(19) United States
(12) Patent Application Publication
(10) Pub. No.: US 2017/0303459 A1
(43) Pub. Date: Oct. 26, 2017

(54) SOIL WORKING UNIT AND METHOD

(71) Applicant: A.M.A. S.P.A., San Martino in Rio (IT)

(72) Inventor: Sergio Scaglia, San Martino in Rio (IT)

(21) Appl. No.: 15/520,675

(22) PCT Filed: Oct. 10, 2015
(86) PCT No.: PCT/IB2015/057763

§ 371 Date: Apr. 20, 2017

(30) Foreign Application Priority Data
Oct. 30, 2014 (IT) VR2014A0000270

(51) Int. Cl. A01B 21/08; A01B 49/06; A01B 23/02; A01B 49/02; A01B 49/00; A01B 21/00

(52) U.S. Cl. CPC A01B 21/086; A01B 23/02; A01B 49/02; A01B 49/06; A01B 21/00; A01B 49/00

(57) ABSTRACT

A unit (UO) for the processing ground (T), comprises at least a first group (G1, D3) for supporting rotating cutting disk means (D) adapted to realize grooves (S) in said ground (T); at least a second group (G2) for supporting plowshare means (V, E) adapted to realize, in correspondence of said grooves (S), cuts (Z) below the surface of said ground (T); and mechanical coupling means (M2) for dynamically connecting said second group (G2) to said first group (G1, D3).

The present invention relates to a soil/ground working unit and its related method. The invention is advantageously applied and mounted on an operating agricultural machine, in particular on an operating machine suitable to the performance of mulching, seeding and/or fertilization treatments, which the following description will make explicit reference to without losing its general nature.

The purpose of the present invention is to provide a working/processing unit through allowing to perform efficient mulching, seeding and/or fertilizing operations on soil for agricultural use, preventing the growth of weeds while maintaining the moisture in the soil, protecting the soil itself from erosion and from the action of heavy rain. Another purpose of the present invention is to realize a working unit, the use of which can provide a more efficient, optimal processing of agricultural soil, thus avoiding the formation of the so-called surface crust on the soil, decreasing the compaction of the soil itself and maintaining its correct structure and temperature. A further purpose is to provide an effective soil working method for agricultural use.

The structural and functional characteristics of the present invention and its advantages over the known art will be clearer and more evident from the claims below, and in particular from an examination of the description that follows, referring to the attached drawings, which show the schematic representations of a preferred but non-limiting embodiment of an agricultural soil working unit, in which:

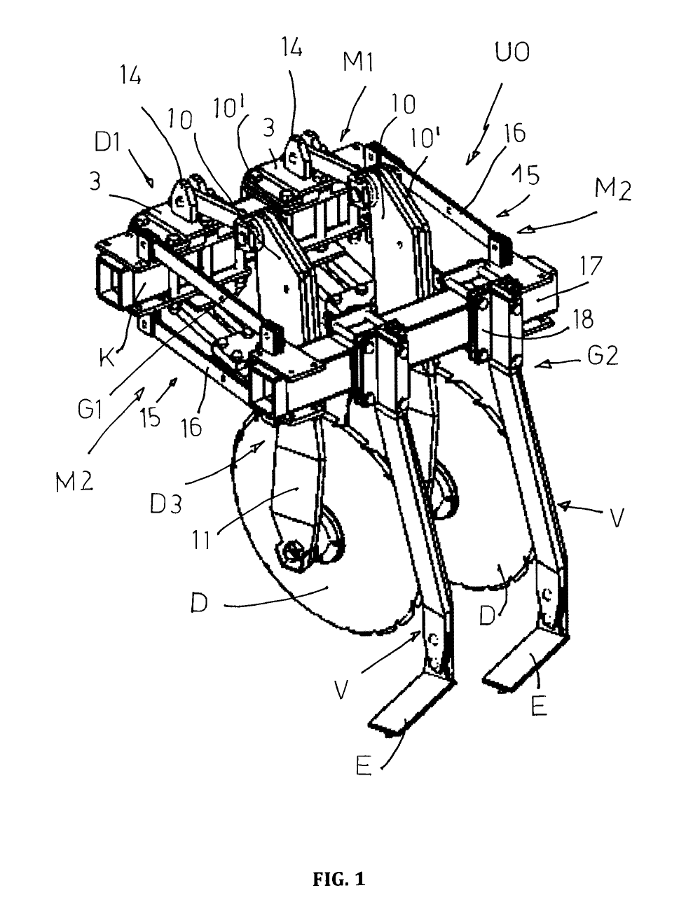

FIG. 1 is a perspective schematic view of a working unit according to the present invention;

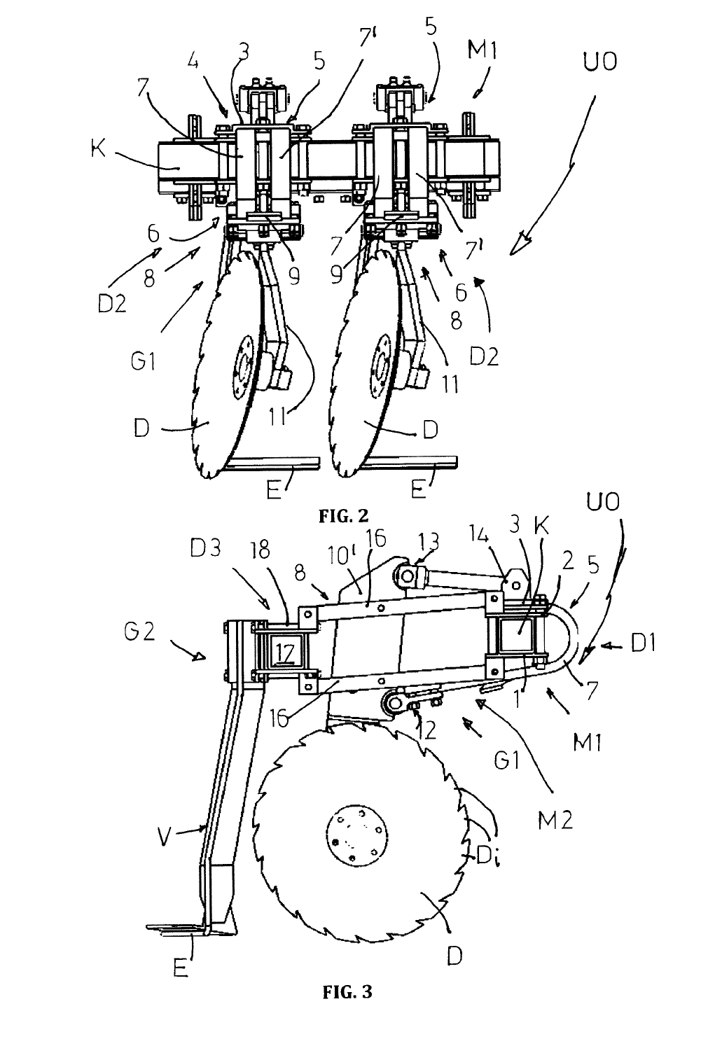

FIG. 2 is a front view of the unit of FIG. 1;

FIG. 3 is a side view of the unit of FIG. 1;

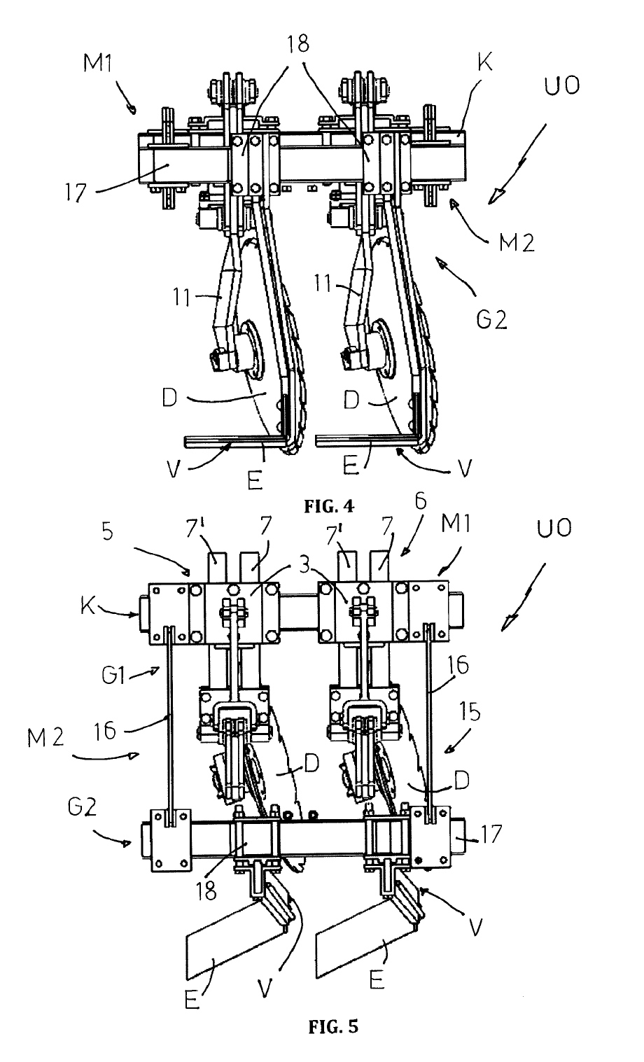

FIG. 4 shows a rear elevated view of the unit of FIG. 1;

FIG. 5 is a top plan view of a detail of the working unit shown in FIG. 1;

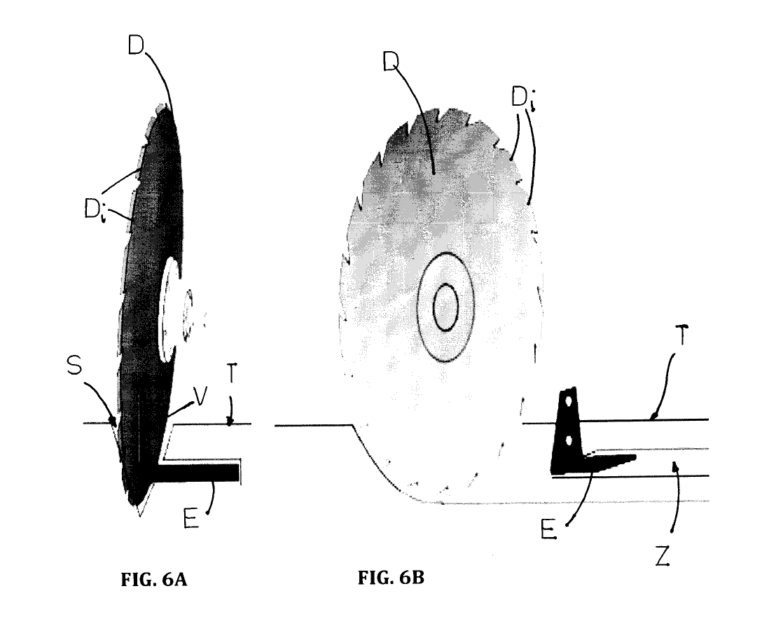

FIG. 6A schematically represents certain components of the working unit with a rear view of the unit itself; and

FIG. 6B schematically represents some components of the working unit with a side view of the unit itself.

With reference to the attached Figures from 1 to 5, UO globally indicates an operating working/processing unit used in the agricultural field and suitable to be mounted to and applied on a transverse, box-profile beam K of the frame (known and not illustrated) of a per-se known operating agricultural machine, used for the processing and treatment of an agricultural ground or soil T.

Unit UO comprises at least one group G1 supporting a rotating cutting disc D having an inclined axis with respect to the vertical (two groups G1 in FIGS. 1, 2, 4 and 5), with said disc D in a preferably convex or spherical-cap configuration, presenting a plurality of uniformly distributed teeth Di on its peripheral surface, in order to run substantially “V” shaped grooves or furrows S (FIG. 6A) into soil T, and at least one group G2 for supporting a “L” shaped ploughshare V or equivalent tool (two groups G2 in FIGS. 1, 2, 4 and 5) to achieve predominantly horizontal slice cuts Z below the surface of soil T itself (FIGS. 6A and 6B), in correspondence to furrow S cut by disc D of group G1, and with its own blade end E, mainly operating parallel to soil T.

Unit UO further comprises fastening devices M1 of group G1 to beam K, as well as coupling and dynamic mechanical connection devices M2 of the G2 group to the G1 group itself.

As shown more clearly in FIGS. 2 and 3, fastening devices M1 comprise two identical plate fastening elements 1 and 2, which can be mutually coupled superiorly and inferiorly from the opposite side of the said box-profile beam K to be fastened to each other and to beam K itself by means of a locking plate 3, disposed above the element 1 and fastened in use to the element 2 by means of suitable bolts.

Plate 3 has a substantially step-shaped profile, allowing to block, between plate 3 itself and element 1, one end 4 of an elastic, “U” shaped body 5, with its concavity facing laterally in FIG. 3.

Specifically, the elastic body 5 is defined by a pair 6 of identical elements 7′ and 7″, put together in a “U” shape configuration, at a given distance between each other, and is suitable to define in use a stress-absorption device D1, suitable to effectively limit the lateral forces generated during soil working, using the high moment of inertia of the pair 6 of elastic elements 7′ and 7″. In particular, the presence of such pair 6 of “U” configured elastic elements 7′ and 7″ allows optimal and controlled oscillation in the vertical direction of unit UO itself.

As shown in FIG. 2, in correspondence with end 8 of body 5, opposite to said end 4, there is a limiting element 9, substantially shaped as a double “T”, which is suitably welded to the frame of the agricultural machine and is advantageously placed between the two elastic elements 7′ and 7″, in such a way as to contain any excessive sliding of elastic elements 7′ and 7″ themselves, both in the transverse and in the longitudinal direction.

This element 9 is suitable in use to define an anti-sliding control device D2, which ensures a constant maintenance of disc D, supported by unit UO, in the correct working position.

As shown in FIGS. 1 and 3, unit UO also comprises a support device D3 for disc D, belonging to group G1 and defined by two parallel plates 10′ and 10″, keyed to an arm 11 for supporting the same disc D.

The two plates 10′ and 10″ of device D3 are coupled to the aforementioned devices D1 and D2 via two rotational pairs 12 and 13, respectively mounted on end 8 of body 5 and on flange 14 of plate 3.

The above-mentioned dynamic connection devices M2 comprise pairs 15 of articulated-arm elements 16, suitable to define an articulated quadrilateral Q structure for the mechanical and dynamical connection of said devices M1 to a transversal box-shaped beam element 17, on which group G2 for the support of ploughshare V is fastened by means of plate fastening elements 18.

In this way, in use, with the agricultural machine moving forward in a given direction with unit UO mounted on it, disc D performs the following operations in its rolling:
it cuts the soil to create furrow S;
immediately after cutting, it projects the soil in the direction opposite to machine movement, thus covering the soil that was just worked with a layer of “fragmented” soil.

Ploughshare V, placed to the rear of disc D with respect to said direction of the agricultural machine (FIGS. 1, 6A and 6B), therefore works directly on the side of furrow S, so as to create an additional furrow under the ground surface, substantially transverse to the soil itself.

In particular, the geometry of ploughshare V is appropriately designed in such a way that blade end E is always in the centre of the “V” of furrow S created by disc D, thereby avoiding the clogging of disc D itself with soil portions on teeth Di, since the blade acts at the side of furrow S, so that soil is literally sliced and raised, thus splitting the surface crust of soil T.

It should be emphasized that unit UO's mulching technique is the best solution to prevent the growth of weeds, retain moisture in the soil, protect the soil from erosion and from the action of heavy rain, avoid formation of the so-called surface crust, decrease compaction and keep the structure and the correct temperature of worked soil. The adaptability and optimization of the process is guaranteed by the possibility to vary the opening of furrow S via the above mentioned groups G1 and G2, and also through rotational-type orientation control devices (not illustrated) of the group G1.

Also worth highlighting is the fact that, by associating a pneumatic seed injection system to unit UO's ploughshare V, so that seeds to be sown are dispensed from blade end E, it is possible to advantageously perform mulched, under-surface seeding activities.

This operation may also be advantageously integrated associating at the same unit UO's ploughshare V a further system for the injection of fertilizer in soil T, so as to perform an optimal fertilization, both local (furrow S) and superficial (at the surface of soil T).

Therefore, the following advantages are obtained from the agronomic point of view:
thanks to the illustrated arrangement and configuration of disc D, unit UO can be used on very hard soils or on soils with crop residues, which can be turned into natural fertilizer;
the seeds thus distributed through unit UO in question are surrounded by two layers of compact soil, which are not “disturbed” by the action of a soil-working tool, are protected from excess humidity, since water drains into furrows S created by disc D, are not in direct contact with fertilizing agents, which places them in the ideal conditions for their development, and are planted at the same height;
the described unit UO allows the simultaneous use of multiple fertilizers, destined to different areas with respect to the position of seed released into the soil.

1. Unit for the processing ground, characterized by comprising at least a first group for supporting rotating cutting disk means adapted to realize grooves in said ground; at least a second group for supporting plowshare means adapted to realize, in correspondence of said grooves, cuts below the surface of said ground; and mechanical coupling means for dynamically connecting said second group to said first group.

2. Unit according to claim 1, characterized in that the said coupling means comprise articulated arms means.

3. Unit according to claim 1, characterized in that it further comprises fixing means for fixing said first group to a support element of a frame of an agricultural working machine.

4. Unit according to claim 3, characterized in that the said coupling means are connected to said fixing means for fixing said first group.

5. Unit according to claim 3, characterized in that it further comprises elastic absorbing means fixed to said fixing means of said first group; control means carried by said elastic absorbing means for controlling the heeling in longitudinal and transverse direction of said absorbing means; and supporting means of said rotating cutting disk means forming part of said first group, said supporting means of said rotating cutting disk means being provided coupled to said elastic absorbing means.

6. Unit according to claim 5, characterized in that said elastic absorbing means comprise an elastic body defined by a pair of “U”-shaped equal elastic elements fixed and arranged adjacent to each other with a given distance.

7. Unit according to claim 6, characterized in that the said control means comprise a limiting element disposed between said two elastic elements of said elastic body.

8. Unit according to claim 5, characterized in that the said supporting means of said rotating cutting disk means comprise a pair of parallel support plates a fixed to an supporting arm of said rotating cutting disk means of said first group.

9. Unit according to claim 7, characterized in that the said pair of plates is mounted at one end of said elastic body by rotoidal means.

10. Unit according to claim 1, characterized in that it further comprises feed means for feeding seed, said feed means being connected to said plowshare means of said second group.

11. Unit according to claim 1, characterized in that it further comprises supply means for supplying fertilizing substances, said supply means being connected to said plowshare means of said second group.

12. Agricultural working machine provided with at least a working unit according to claim 1.

13. Method for processing a ground, characterized in that it comprises a step of forming grooves in said ground and a step of making cuts of said ground in correspondence with said grooves along at least one predetermined direction with respect to said ground.

14. Method according to claim 13, characterized in that it comprises a further step of feeding seeds in said grooves and/or in said cuts.

15. Method according to claim 13, characterized in that it comprises a further step of fertilization of said ground in correspondence with said cuts.
